(19) United States
(12) Patent Application Publication
(10) Pub. No.: US 2012/0128861 A1
(43) Pub. Date: May 24, 2012

(54) SUBSTANCE-RETAINING CEREAL

(75) Inventors: Shinichi Kitamura, Sakai-shi (JP); Makoto Nakaya, Sakai-shi (JP); Akiko Kubo, Amagasaki-shi (JP); Tadahiko Inukai, Nagoya-shi (JP)

(73) Assignee: OSAKA PREFECTURE UNIVERSITY PUBLIC CORPORATION, Sakai-shi, Osaka (JP)

(21) Appl. No.: 13/384,556

(22) PCT Filed: Jul. 22, 2010
(86) PCT No.: PCT/JP2010/062308

§ 371 Date: Jan. 17, 2012

(30) Foreign Application Priority Data
Jul. 22, 2009 (JP) 2009-171634

(51) Int. Cl. A23L 1/182

(52) U.S. Cl. 426/618; 426/442

(57) ABSTRACT

Provided are rice grains where various water-soluble high molecular substances are retained without applying pressure to the rice grains. Grains of mutant rice (wx/ae rice), which is deficient in both amylopectin branching enzyme (BEIIb) and amylose synthetase I (GBSSI), are immersed in an aqueous solution of a water-soluble high molecular substance such as digestion resistant dextrin, arabinogalactan, or polyphenol under ordinary pressure at room temperature and are then dried at 60° C. or less, preferably about 50° C., thereby producing rice grains impregnated with and retaining the high molecular substance.

### TECHNICAL FIELD

The present invention relates to a substance-retaining cereal and processed food thereof and relates to a method of producing the cereal. More specifically, the present invention relates to rice grains retaining a substance, such as a high-molecular substance, which has been taken into the rice grains under non-pressurized conditions and relates to rice grains that can be cooked in the state where the substance to be retained has been taken in the rice grains.

### BACKGROUND ART

PTL 1(JP-A-2006-180806) discloses a cereal containing an extrinsic substance having high affinity to amylose present in the cereal. The cereal containing such an extrinsic substance having an affinity to amylose, for example, water-soluble dietary fibers such as digestion resistant dextrin or locust bean gum, can prevent aging of starch present in the cereal and not only gives good texture after cooking but also maintains the good texture after chilled storage. In addition, water-soluble dietary fibers are not digested and can therefore exhibit a function of preventing a sharp increase in postprandial blood glucose level. Accordingly, cereals provided with various health-maintaining or disease-preventing functions that are possessed by such water-soluble dietary fibers are provided.

The above-described cereals are produced by high-pressure treatment, specifically, application of a pressure of about 100 to about 9000 atmospheres to cereal grains, in an aqueous solution dissolving an extrinsic substance having affinity to amylose. On this occasion, in order to avoid degradation in food texture of the cereal, the pressurization is preferably performed at a temperature of not higher than 50° C.

NPl 1 discloses double mutant (wx/ae) non-glutinous rice where both amylose synthetase I (GBSSI) and amylopectin branching enzyme IIb (BEIIb) are deleted from wild-type non-glutinous rice. The double mutant is selected from strains (mutants) obtained by hybridizing a wx mutant in which GBSSI is deleted and an ae mutant in which BEIIb is deleted.

Iodine staining of albumen cross-section or X-ray diffractometry shows that the molecular structure of amylopectin of this double mutant is different from those of the wild-type and the wx mutant.

### CITATION LIST

### Patent Literature

PTL 1: JP-A-2006-180806

### Non Patent Literature

NPL 1: Kubo, A., et al., Journal of Cereal Science, (2007), doi:10.1016/j.jcs.2007.08.005

### SUMMARY OF INVENTION

### Technical Problem

Incidentally, in the method described in PTL 1, treatment of a cereal for retaining water-soluble dietary fibers, etc. must be conducted under high pressure. This treatment tends to cause cracking or fracture in the cereal grains and there are concerns that it may decrease the commercial value of the cereal subjected to this treatment.

NPL 1 refers to the structure of amylopectin of rice having the double mutant (wx/ae) rice, but other characteristics are not reported and are unknown. Accordingly, the present inventors have further developed studies of characteristics of the wx/ae rice and have obtained findings that the water absorption (ratio) of this rice is higher than those of wild-type non-glutinous rice (WT rice) and glutinous rice (wx mutant rice) and that the sucrose content of wx/ae rice is higher than those of WT rice and wx mutant rice whereas the total carbohydrate content of wx/ae rice is lower than those of WT rice and wx mutant rice. That is, it is believed that due to the high content of sucrose, the wx/ae rice immersed in water absorbs a larger amount of water compared with the cases of wild-type non-glutinous rice and glutinous rice (wx mutant rice) and shows a high osmotic pressure. The present inventors have conceived that it is possible to impregnate and retain wx/ae rice with a high-molecular substance by immersing wx/ae rice in an aqueous solution of the high-molecular substance to be impregnated and retained in the wx/ae rice. Accordingly, wx/ae rice grains were actually immersed in an aqueous solution of a high-molecular substance to confirm that the high-molecular substance in the immersion fluid is impregnated and retained in the rice grains even under conditions of ordinary pressure.

The present invention has been made in view of the above-described circumstances of the art, and it is an object of the present invention to provide cereals, in particular, rice grains, retaining various substances under non-pressurized conditions.

### Solution to Problem

In the present invention, a substance-retaining cereal is produced by immersing cereal grains in an aqueous solution or dispersion of a substance to be retained under non-pressurized conditions for impregnating the cereal grains with the substance and then drying the immersed cereal grains.

### Effects of Invention

According to the present invention, a substance-retaining cereal is provided without pressuring the cereal. Consequently, the substance to be retained in rice is not limited to the water-soluble substances, disclosed in PTL 1, having affinity to amylose and can be selected from a larger number of substances, and application to functional foods that promote health is broadened.

### BRIEF DESCRIPTION OF DRAWINGS

FIG. 1 includes images showing changes in volume of milled rice grains due to swelling, wherein images (a) and (b) show, respectively, the states before and after immersing for 30 min, and each show, from the left, WT rice (non-glutinous rice) grains, wx mutant rice grains, and wx/ae rice grains.

FIG. 2 is a graph showing a relationship between immersing time and the amount of absorbed water in unmilled rice grains.

FIG. 3 is a graph showing a relationship between immersing time and the amount of absorbed water in milled rice grains.

FIG. 4 includes graphs showing osmotic pressures of sucrose in unmilled rice grains, wherein graph (a) shows osmotic pressures of 100 g of unmilled rice grains, graph (b) shows osmotic pressures of 100 mL of unmilled rice grains.

FIG. 5 includes stained microscopic images of milled rice grains retaining arabinogalactan by the method of the present invention.

### DESCRIPTION OF EMBODIMENTS

In the substance-retaining cereal of the present invention, a substance is impregnated and retained in cereal grains under non-pressurized conditions utilizing a difference in osmotic pressure between the inside and the outside of the cereal grains. This cereal is produced, as described below, by immersing cereal grains in an aqueous solution or dispersion of a substance to be retained, such as a high-molecular substance, under ordinary pressure without pressurizing for impregnating the cereal grains with the substance and then drying the cereal grains at a temperature of not higher than 60° C., as necessary, to retain the substance in the cereal grains.

In the present invention, the term “ordinary pressure” refers to an atmospheric pressure condition and refers to a state where no specific pressurizing operation is performed. The retaining of a substance may be performed under pressurized or reduced pressure, but since the cereal of the present invention is produced utilizing a high osmotic pressure of cereal grains, as described below, pressurizing operation or pressure-reducing operation hardly affects achievement of the retaining.

The substance to be retained that can be used in the present invention may be either a water-soluble substance or a water-insoluble substance. The molecular weight of the substance is not particularly limited, but the substance to be retained preferably used is a substance where immersion water containing the substance has an osmotic pressure smaller than the osmotic pressure inside the cereal grains. An example of the substance to be retained is a water-soluble high-molecular substance. The present invention utilizes a difference in osmotic pressure between the inside and the outside of cereal grains immersed in an aqueous solution of a substance to be retained. As described below, since the cereal grains that are used as a supporter in the present invention have a high content of sucrose, the cereal grains themselves probably have a high osmotic pressure. When the cereal grains are immersed in an aqueous solution dissolving a substance to be retained and having a low osmotic pressure, water present outside the cereal grains moves into the insides of the cereal grains due to the difference in osmotic pressure between the inside and the outside of the cereal grains. It is thought that this movement of water is accompanied by infiltration of the substance to be retained that is contained in the immersion fluid into the cereal grains, retaining the substance in the cereal grains.

In the case where the substance to be retained is water-soluble, the water-soluble substance is preferably a high molecular substance. If the water-soluble substance is of low molecular weight, the osmotic pressure of immersion water dissolving the substance becomes high. As a result, the difference in osmotic pressure between the inside and the outside of cereal grains is reduced not to allow water and the substance to infiltrate into the cereal grains.

In the case where the substance to be retained is water-soluble, the molecular weight thereof is not particularly limited as long as the substance is not electrolytic. However, if the molecular weight is small, the molar concentration becomes large even if the amount of the substance dissolved in an immersion fluid is small. Consequently, the difference in osmotic pressure between the inside of cereal grains and the immersion fluid does not increase, and thereby the movement of water and the solute and the amount of the retained substance as the result thereof become small. Accordingly, the molecular weight of the water-soluble substance to be retained is 300 or more and more preferably 1000 or more.

Contrarily, in the case where the solute (substance to be retained) is of high molecular weight, the molar concentration is lower than that in the case of low molecular weight when the weight concentration is the same. Consequently, the osmotic pressure of the immersion fluid is lower than that inside the cereal grains to increase the difference in osmotic pressure between the inside and the outside of the cereal grains. As a result, the amounts of moved water and solute are larger than those in the case of a solute with a low molecular weight. Therefore, the amount of the retained substance is higher in the case of a high molecular substance compared with that in the case of a low molecular substance. From these viewpoints, the substance to be retained of the present invention is preferably a high molecular substance, and the upper limit of the molecular weight is not particularly limited. However, a substance having a high molecular weight has a large molecular size, and such a molecule does not enter the voids of cereal grains and may be hardly retained in the cereal grains. Accordingly, the upper limit of the molecular weight of the water-soluble high molecular substance is 5000000, preferably 1000000.

Specific examples of the high molecular substance that can be used in the present invention include digestion resistant dextrin, arabinogalactan, polyphenol, polypeptide, and polysaccharides such as pullulan; and proteins such as gelatin. Examples of the digestion resistant dextrin include roasted dextrin treated with α-amylase and transglycosidase (see JP-A-Hei 2-100695) and those prepared by treating organic acid- or inorganic acid-equilibrium adsorbing polysaccharides with heat moisture (see JP-A-Hei 8-41104). A specific example is “Pine Fiber” (trade name, Matsutani Chemical Industry Co., Ltd.). The digestion resistant dextrin is known to be indigestible by human and animals and has an effect of suppressing an increase in blood glucose level to adjust the blood glucose level, an effect of lowering serum cholesterol and neutral fat, and an effect of regulating the functions of the intestines.

Arabinogalactan is a water-soluble polysaccharide having arabinose and galactose as constituent sugars and is a kind of dietary fibers. In particular, the arabinogalactan disclosed in International Patent Publication No. WO2005/105852 or JP-A-2008-208102 is known to have an antidiabetic activity and gut immunity-stimulating activity and is used as an antidiabetic agent or an antiallergic agent. In addition, water-soluble polysaccharides such as pullulan can be suitably used. Pullulan is a polysaccharide having glucose as a constituent sugar and is used as a thickener, a film-forming agent, etc. A cereal retaining pullulan has a possibility of exhibiting a function that has not been known yet.

Not only the water-soluble polysaccharides such as digestion resistant dextrin, arabinogalactan, and pullulan, but other water-soluble high molecular substances, for example, polyphenol can be also suitably used. Polyphenol is a general name of substances derived from plants and having a large number of phenolic hydroxyl groups in the molecule. Examples of the polyphenol include catechin, anthocyanin, isoflavone, flavone, ellagic acid, and chlorogenic acid. These polyphenol have various effects and functions, such as an antioxidant effect, and prevent aging of human and animals and improve preservation of a processed food obtained from the retaining rice. These high molecular substances are merely examples of the substance that can be retained in the present invention.

The substance to be retained may not be water-soluble. Hydrophobic substances, which are water-insoluble, can be also used as the substance to be retained. The hydrophobic substance also infiltrates into cereal grains when water as a solvent of an immersion fluid moves into the cereal grains due to a difference in osmotic pressure and is retained in the cereal grains by drying. Throughout the specification, the term hydrophobic substance refers to a substance that is insoluble in water and forms an emulsion when dispersed in an immersion fluid at an ordinary temperature. The hydrophobic substance to be retained may be a low-molecular-weight substance, for example, having a molecular weight of smaller than 300. The hydrophobic substance is not dissolved in water and does not therefore cause osmotic pressure in the immersion fluid, even if a hydrophobic substance having a low molecular weight is dispersed in water. Accordingly, the substance to be retained in the present invention may be a hydrophobic substance that forms an emulsion when dispersed in an immersion fluid at an ordinary temperature or may be a water-soluble high molecular substance as described above. The molecular weight of the hydrophobic substance is not particularly limited, but in the case of a hydrophilic substance, preferably used is a substance that causes a large difference between the osmotic pressure of an immersion fluid where the substance is dissolved or dispersed in water and the osmotic pressure inside cereal grains, and in the case of a water-soluble substance, preferred is a substance having a molecular weight of 300 or more.

The term retaining in the present invention does not refer to merely adhesion to cereal grain surfaces, but refers to a state in which a substance to be retained has infiltrated into voids of cereal grains or the insides of cereal grains and is stably retained, as shown in FIG. 5. Accordingly, even if the substance-retaining cereal grains are immersed in water again, the retained substance is hardly eluted (released) into the water. In addition, the retained substance probably passes through the cell membrane and remains in the cytoplasm. Some types of substances to be retained do not pass through the cell membrane and are impregnated and retained in voids of cereal grains. The present invention does not exclude these cases.

The supporter that is used in the present invention is a cereal. Any cereal can be used without limitation, and examples thereof include rice, wheat, barnyard millet, and millet. In light of the application range of a cereal retaining a substance, rice is particularly preferred. In order to produce a cereal retaining a substance according to the present invention, the osmotic pressure inside cereal grains must be higher than that of an immersion fluid. The immersion fluid moves into the inside of the cereal grains due to the osmotic pressures of the inside and the outside of the cereal grains, and on this occasion, the water-soluble molecule dissolved in the immersion fluid or the hydrophobic molecule dispersed in the immersion fluid moves inside the cereal grains together with the water and is retained therein.

Specifically, in the present invention, the above-mentioned wx/ae rice is preferably used, but any rice that causes an osmotic pressure with respect to an immersion fluid due to a high content of sugars, such as sucrose, inside the cereal grains can be used. The osmotic pressure of usual non-glutinous rice or glutinous rice is low, and, therefore, the amount of the retained substance is low. Compared to this, the osmotic pressure of the above-described wx/ae rice is high, and, therefore, a larger amount of substance can be retained. The wx/ae rice is mutant rice (wx/ae rice) having deficiencies in amylopectin branching enzyme (BEIIb) and amylose synthetase I (GBSSI) (see NPL 1). This rice contains a larger amount of sucrose than the non-glutinous rice and glutinous rice (see Table 1). A larger content of sucrose raises the osmotic pressure of the rice, and thereby a larger amount of the substance to be retained in the immersion fluid is retained. In the present invention, in addition to wx/ae rice, rice containing sucrose in a high content, specifically, a content of 1.5% or more, preferably 2% or more, and more preferably 3% or more as unmilled rice, can be preferably used. Infiltration into milled rice (rice after removal of the surface layers, such as germ and bran, by rice milling of unmilled rice) is easier than infiltration into unmilled rice, and in the case of using milled rice, the content of sucrose in milled rice may be 0.5% or more, preferably 1.0% or more, and desirably 1.5% or more. The sucrose content in milled rice is the content in milled rice having a weight grain milling percentage (weight ratio of the milled rice to the unmilled rice) of 85% or more and 90% or less. Wx/ae rice is characterized by its high content of sucrose, but the present invention is characterized by impregnation and retention of a substance by means of a difference in osmotic pressure between the inside and the outside of cereal grains. Accordingly, in addition to wx/ae rice, rice having a high osmotic pressure by the presence of sucrose or another non-electrolyte can be used as retaining rice. Throughout the specification, the sucrose content is a value determined by the method of Scofield, et al. described in Examples below.

In wx/ae rice, the sucrose content is high, and water moves into the inside of the rice grain by means of the difference in osmotic pressure between the inside and the outside of the rice grain, so wx/ae rice absorbs much water. Accordingly, the amount of water absorbed by cereal grains can be used as an index of the osmotic pressure inside the cereal grains. That is, rice having a water-absorbing power higher than those of non-glutinous rice and glutinous-rice, specifically, a water-absorbing power of not less than 1.5, preferably 1.6, desirably not less than 2.0, when immersed in water of 15° C., is preferably used in the present invention. Incidentally, the water-absorbing power is defined as a ratio of the volume of cereal grains after immersing to the volume of the cereal grains immediately after the starting of the immersing.

The rice may be either threshed unmilled rice or rice (milled rice) after removal of the surface layers, such as germ and bran, by milling unmilled rice, but unmilled rice is low in water-absorbing rate compared with milled rice and cannot be expected to retain a large amount of a substance within a limited time. Accordingly, milled rice is used in the present invention preferably. However, if unmilled rice has a high water-absorbing rate, the rice can retain a large amount of a high molecular substance. Furthermore, cereals other than rice are similarly used by removing the outer husks by threshing so that water absorption is not inhibited by the husks.

The saturated amount of retention, i.e., the maximum amount of a substance to be retained in cereal grains (retaining capacity of cereal), depends on the osmotic pressure of the cereal and the molecular weight of the substance to be retained. Movement of water continues until the osmotic pressure of the cereal and the osmotic pressure of the immersion fluid become equal to each other and stops at the time the movement rates equilibrate. The amount of retention is proportional to the amount of moved water. Therefore, a larger difference between the osmotic pressure inside cereal grains and the osmotic pressure of the immersion fluid causes a larger amount of movement, i.e., a larger amount of retention. The osmotic pressure inside cereal grains is caused by sucrose and other non-electrolytes present in the cereal grains, as described above. The osmotic pressure is proportional to the number of moles of the dissolved solute per unit quantity (molar concentration of immersion fluid). Therefore, when the weight concentrations are the same, the osmotic pressure of an immersion fluid is decreased with an increase in molecular weight of the substance to be retained, resulting in an increase in the amount of movement of the immersion fluid. Thus, the saturated amount of retention to a cereal depends on the osmotic pressure of the cereal and the molar concentration of the substance to be retained.

In the case where the substance to be retained is a high molecular substance or a water-insoluble substance, the osmotic pressure of the immersion fluid is negligibly low compared with the osmotic pressure of the retaining cereal. Therefore, the amount of retention increases with increase of a concentration of the immersion fluid. For example, the above-mentioned arabinogalactan or pullulan is retained in WT rice (milled rice) grains in an amount of less than 1% of the retaining rice, but is retained in wx/ae rice (milled rice) grains in an amount of 1% or more. Furthermore, the high molecular substance is retained in wx/ae rice (milled rice) grains in an amount of 2% or more by increasing the concentration of the substance to be retained in the immersion fluid.

The retaining cereal of the present invention is prepared by a step of immersing cereal grains in an aqueous solution or dispersion of the substance to be retained under ordinary pressure and, as necessary, a step of drying the immersed cereal grains. The concentration of the aqueous solution or the dispersion is appropriately adjusted and is about 1 to 50%, preferably about 2 to 20%. The immersion fluid may dissolve or disperse one kind of substance to be retained or two or more kinds of substances to be retained. In the case of a dispersion, it is desirable to disperse the substance to be retained in a state of particles as fine as possible treated with, for example, ultrasonic waves or high speed stirring.

The amount of retention is increased with the time of immersion, but is sharply increased in a time of about 30 min to 1 hr and reaches saturation in about several hours. Accordingly, the immersion time is at least 30 min, preferably 1 hr or more, desirably about 2 hr, and 5 to 6 hours at the longest. Even if the immersion time is shorter than 30 min, retention is possible. Contrarily, in some cases, an immersion time longer than 6 hr is better for retention.

The immersion temperature is also not particularly limited, and retention may be performed at room temperature (1 to 30° C.) without heating. However, it is allowed to heat at about 50° C. Heating accelerates the infiltration rate in any way to reduce the time for reaching equilibrium. As a result, the productivity is improved.

The immersed cereal grains are taken out from the aqueous solution or dispersion and are then dried. The drying is also performed under ordinary pressure, and the drying temperature is 60° C. or less, preferably about 50° C. A low temperature of less than 30° C. tends to cause insufficient drying, and drying at a temperature higher than 60° C., at near 100° C., is similar to a state of cooking the rice. As a result, the rice may gelatinize not to be cooked afterward. Accordingly, the drying is preferably performed at a temperature of not higher than 60° C., more preferably 50° C. or less. The drying may be also performed under ordinary pressure, but may be performed under reduced pressure. The rice grains dried at a temperature of not higher than 60° C. are low in cracking or fracture and maintain shapes similar to those of milled rice grains. This rice can be stably stored for a long time. The cereal grains may be naturally dried without heat treatment.

The obtained retaining rice can be eaten as cooked rice by cooking the retaining rice similarly to usual milled rice or unmilled rice. In addition to cooked rice, examples of processed rice foods include risotto, rice gruel, and rice soup; retort pouch foods and frozen foods thereof; and rice cakes such as rice dumpling and rice cracker prepared by processing cooked rice. The processed rice food may be prepared by processing retaining rice by any known method as in the case of using WT rice as a raw material.

Furthermore, the processed rice food can be prepared by treating immersed rice with heat at a temperature higher than 60° C. without going through a dried state. That is, immersed rice may be heated or steamed and then directly subjected to a subsequent step such as mashing. Furthermore, immersed rice may be directly cooked, without drying, to be eaten as cooked rice or gruel. Cereals other than rice can be processed in accordance with the method described above, as in rice.

The present invention will now be described in further detail based on the following Examples, but is not limited to the Examples shown below.

### Example 1

### Preparation of Unmilled and Milled Rice Grains

Amphicytula of Kinmaze, which is Japonica rice, was treated with N-methyl-N-nitrosourea (MNU) to obtain mutated wx rice EM21 (GBSSI deficient variant, prepared in accordance with the method of Satoh and Omura, et al., 1979), and the resulting wx rice EM21 was hybridized with ae rice EM16 (BEIIb deficient variant) to obtain a wx/ae double mutant cell line, AMF18. This cell line was cultivated in Osaka Prefecture University and was harvested 30 days after blooming. As controls, wild-type (WT rice) Kinmaze and wx rice EM21 were used. These wild-type rice and mutated rice were threshed to obtain unmilled rice. The unmilled rice was milled with a rice mill for testing (MB-RC17 available from Yamamoto Electric Corp.) to obtain milled rice where bran was removed at a weight milling rate of 85% or more and 90% or less.

### [Component Analysis of Unmilled Rice]

Unmilled WT rice, wx rice, and wx/ae rice were subjected to nutritional component analysis in accordance with a method generally used for food analysis. Table 1 shows the results. As shown in Table 1, the water content of wx/ae rice was larger than those of WT rice and wx rice. It was characteristic that the sucrose content of wx/ae rice was higher than those of WT rice and wx rice whereas the total carbohydrate content of wx/ae rice was less than those of WT rice and wx rice. Accordingly, in order to perform further detailed comparison of sucrose contents, the sucrose contents of these types of rice were measured by the method of Scofield, et al. (Graham. N. Scofield, et al., Journal of Experimental Botany Advance Access, pp. 1-13, Nov. 30, 2006, “The role of the sucrose transporter, OsSUT1, in germination and early seedling growth and development of rice plants”). Table 2 shows the results. As shown in Table 2, the sucrose content of unmilled wx/ae rice was about 2.9% whereas those of unmilled WT rice and wx rice were about 1.1% and about 1.3%, respectively, and the sucrose content of milled wx/ae rice was 1.9% whereas those of milled WT rice and wx rice were about 0.2% and about 1.3%, respectively.

TABLE 1
Component in unmilled rice

| Component | WT rice | wx mutant rice | wx/ae mutant rice | Unit |
|---|---|---|---|---|
| Water | 15.6 | 16.1 | 18.4 | % |
| Protein | 7.3 | 7.6 | 7.8 | % |
| Lipid | 3.1 | 2.8 | 5.0 | % |
| Ash | 1.4 | 1.4 | 1.7 | % |
| Carbohydrate | 69.8 | 69.3 | 58.9 | % |
| (Sucrose) | (0.78) | (1.18) | (3.20) | % |
| Dietary fibers | 2.8 | 2.8 | 8.2 | % |
| Energy | 342 | 338 | 328 | kcal/100 g |

TABLE 2
Sucrose content (mg/100 mg)

| | WT rice | wx rice | wx/ae rice |
|---|---|---|---|
| Unmilled rice | 1.03 ± 0.05 | 1.25 ± 0.05 | 2.94 ± 0.06 |
| Milled rice | 0.23 ± 0.01 | 0.25 ± 0.00 | 1.94 ± 0.05 |
| (Weight grain milling | 86% | 86% | 90% |
| percentage) | | | |

### [Swelling Test]

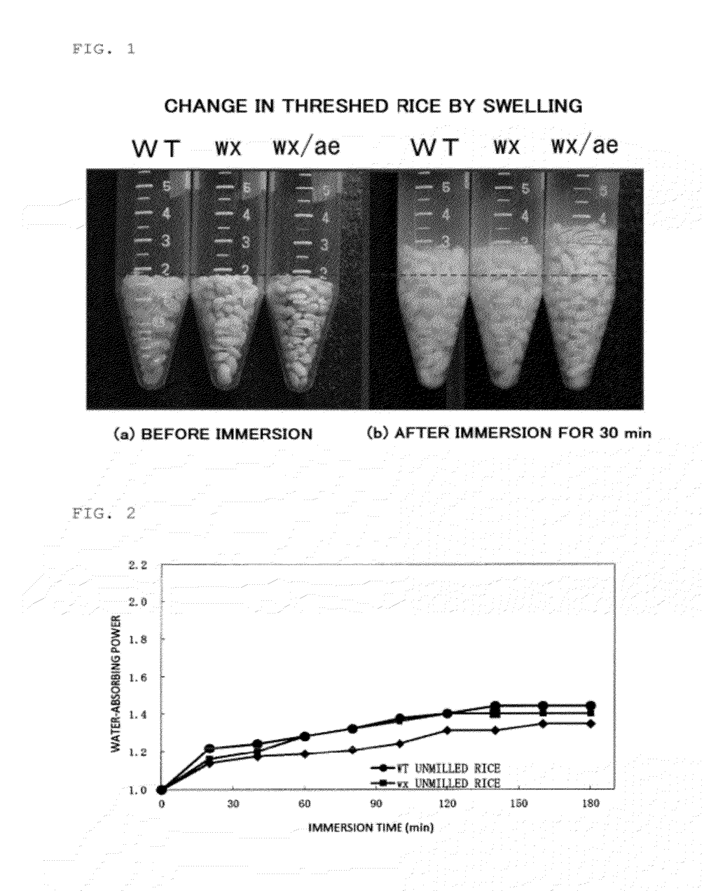

The same amounts of milled wild-type rice (WT rice), wx rice, and wx/ae rice were put in the respective test tubes, and water was added thereto for immersing the rice in water at room temperature. FIG. 1 shows the results. As obvious from FIG. 1, wx/ae rice showed a swelling property greater than those of other types of rice.

### [Water Absorption Test]

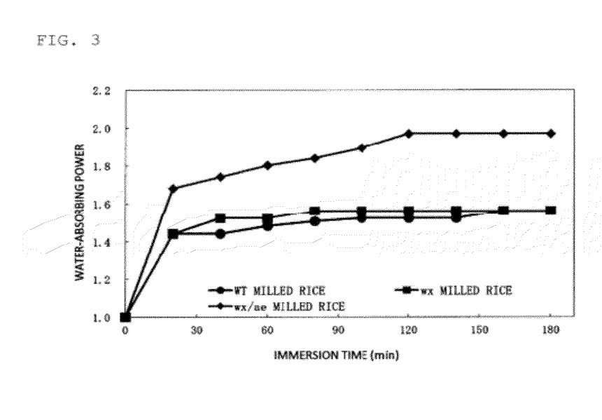

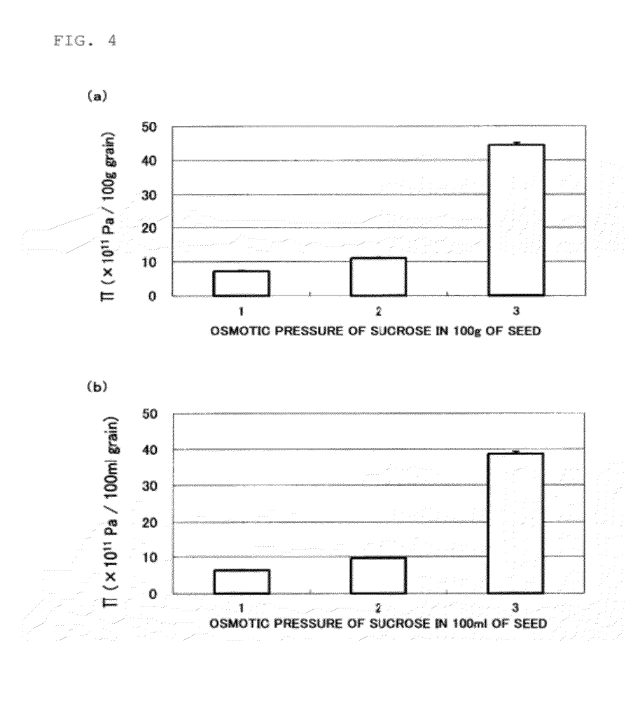

The water-absorbing powers of wild-type rice (WT rice), wx rice, and wx/ae rice were measured. The measurement was conducted for unmilled and milled rice of each type. 10 g of unmilled or milled rice were put in a 100-m measuring cylinder, and 70 mL of water adjusted at 15° C. in advance was poured therein, followed by storing in a thermostat chamber at 15° C. The measuring cylinder was taken out at every 20 minutes, and the volume of the rice grain portion was measured. The ratio of the volume at immediately after each immersion time to the volume at immediately after the start of the storage was defined as the water-absorbing power. The results are shown in FIG. 2 (unmilled rice) and FIG. 3 (milled rice). The results are each an average value of the results obtained using six measuring cylinders.

All of WT rice, wx rice, and wx/ae rice drastically absorbed water in the first 20 min and then mildly absorbed water, but absorption of water almost stopped on and after 120 min. Changes in water-absorbing power of WT rice and wx rice were approximately the same. The water-absorbing powers of wx/ae rice in the state recognized as equilibrium were 1.4 in unmilled rice and 1.6 in milled rice to show a change highly similar to those of other rice. The final water-absorbing power of milled wx/ae rice was 2.0, which was about 1.25-fold that of WT rice or wx rice, whereas the final water-absorbing power of unmilled wx/ae rice was 1.3, which was slightly lower than those of WT rice and wx rice.

It is thought that this large difference in water absorption amount of the unmilled and milled wx/ae rice was caused by the bran on surfaces of the unmilled rice grains inhibiting albumen from absorbing water. The water absorption amount of unmilled wx/ae rice was slightly lower than those of WT rice and wx rice, suggesting that the power of bran inhibiting water absorption (power preventing albumen from swelling) in wx/ae rice is higher than those in WT rice and wx rice. The volume of starch purified from such mutant rice did not change even if it was immersed in water at 50° C. for 30 min as in purified starch prepared from WT rice and wx rice (the results are not shown). It was therefore suggested that the high water absorption amount of wx/ae rice is caused by substances such as sucrose contained in wx/ae rice in an amount larger than those in WT rice and wx rice, not by starch.

### [Regarding Osmotic Pressure]

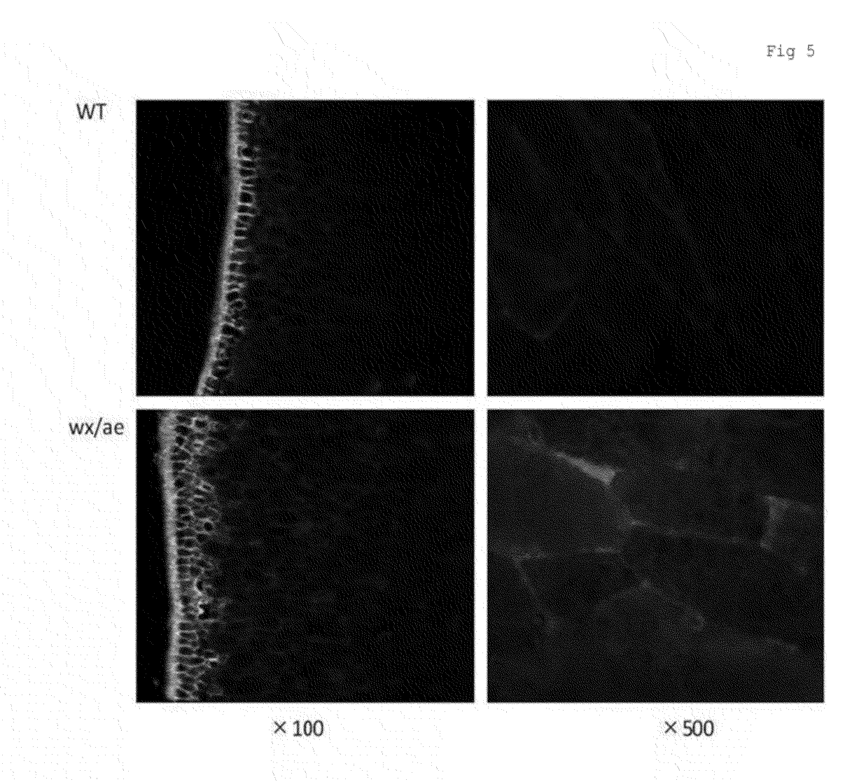

Then, the osmotic pressure generated by immersing rice in water was calculated from the concentration of sucrose. FIG. 4 shows the results. The osmotic pressure of wx/ae rice was estimated to be about 6-fold that of WT rice and about 4-fold that of wx rice.

### [Retaining of Substance 1]

As substances to be retained, arabinogalactan, a water-soluble high-molecular substance, derived from sweet potato and pullulan, a polysaccharide, produced by yeast were used. The arabinogalactan was that disclosed in International Patent Publication No. WO2005/105852, and the pullulan was a commercially available product (molecular weight: about 280000) manufactured by Hayashibara Biochemical Labs., Inc.

### (Drying at 50° C.)

A rice sample (milled wx/ae rice) was washed with distilled water three times and was then wiped with wiping paper (trade name: KimWipes, available from Nippon Paper Crecia Co., Ltd.) to remove water on the rice grain surfaces. Then, 10 mL of a solution of arabinogalactan or pullulan at each concentration shown in Table 3 was added to a vial containing about 3 g of the rice sample, and the sample was lightly stirred. The time at which the solution was added was defined as the starting time, and the sample was stirred at every 30 min. After completion of immersion for 2 hr, the immersed rice grains were immediately washed with distilled water three times, water on the surfaces of rice grains were removed with wiping paper, and then the rice grains were dried in a drier set at 50° C. until a constant weight was obtained. As a control, a rice sample that was immersed in distilled water and then dried was used. The rate of increase in weight after drying of the dried milled rice sample immersed in the solution of arabinogalactan or pullulan to the dried milled rice control immersed in distilled water was calculated. Table 3 shows the results.

TABLE 3

| | | Increase in weight¹⁾ after drying (%) |
|---|---|---|
| wx/ae | 20% AG | 4.3 |
| | 10% AG | 2.2 |
| | 1% AG | 0.6 |
| wx/ae | 10% PUL | 2.1 |
| | 5% PUL | 1.4 |
| | 1% PUL | 0.6 |

(Drying at 100° C.)

As in above, 10 mL of a solution of arabinogalactan or pullulan at each concentration shown in Table 4 was added to a vial containing about 5 g of rice sample so that the rice retains the high molecular substance, and an increase in weight was determined. Table 4 shows the results.

TABLE 4

| | | Increase in weight¹⁾ after drying (%) |
|---|---|---|
| 10% PUL | WT | 0.3 |
| | wx/ae | 1.5 |
| 10% AG | WT | 0.2 |
| | wx/ae | 2.5 |

As obvious from Tables 3 and 4, the high molecular substance was retained in the wx/ae rice grains in a weight amount of 1% or more, in a satisfactory case, 2% or more, of the unimmersed rice by immersing the rice grains in an aqueous solution containing the high molecular substance in a concentration of 5 to 10% for about 2 hr. Contrarily, WT rice, which is non-glutinous rice, retained the high molecular substance in an amount of only less than 0.5%. Thus, it was confirmed that the high molecular substance was retained in the wx/ae rice grains under ordinary temperature and ordinary pressure.

The wx/ex rice grains dried at 50° C. did not have fracture on the surfaces and were not cracked. In addition, the wx/ae rice could be eaten as cooked rice by cooking it similarly to usual milled rice. Contrarily, in the case of drying at 100° C., the rice grains stuck together into a rice cracker-like state, but could be eaten. In particular, in the case of retaining arabinogalactan, the rice could be eaten very deliciously as rice cracker-like rice cake.

### (Retaining of Substance 2)

High molecular substances shown in Table 5 were retained as substances to be retained in rice grains by the same procedure as in above. Drying was performed at a temperature of 50° C. The aqueous solution of gelatin gelated at ordinary temperature and could not be therefore used for impregnation and retention as gelatin. Accordingly, immersion was performed using the immersion liquid warmed at 50° C. The average molecular weights of the substances used for retaining were DX: 18000, gelatin: 50000 to 100000, Cluster dextlin: 500000, and digestion resistant dextrin: 2000 (the data are those prepared by the respective manufacturing companies). As shown in Table 5, these high molecular substances could be satisfactorily retained in rice grains.

TABLE 5

Increase in weight
after drying (%)
Immersion time

| | | 2 hr | 10 hr |
|---|---|---|---|
| 2% GX | WT | 0.00 | 0.47 |
| | wx/ae | 4.73 | 3.65 |
| 10% Gelatin | WT | −4.04 | −5.14 |
| | wx/ae | 3.78 | 1.62 |
| 10% Cruster Dextlin | WT | 0.00 | 0.00 |
| | wx/ae | 4.19 | 4.35 |
| 10% Digestion Resistant Dextlin | WT | 0.00 | 0.00 |
| | wx/ae | 4.25 | 4.78 |

GX: 4-O-Methyl-D-Glucurono-D-Xylan: Batch 0204-I Institute of Chemistry, Slovak Academy of Sciences
Gelatin: Gelatin from porcine skin, Type A, SIGMA
Cluster Dextlin: Lot No. 16.6.19 Ezaki Glico Co., Ltd.
Digestion resistant dextrin: Matsutani Chemical Industry Co., Ltd. Pine fiber

### INDUSTRIAL APPLICABILITY

According to the present invention, rice retaining various types of high molecular substances, for example, digestion resistant dextrin or arabinogalactan which contributes to prevention of diabetes, is provided. As a result, rice or processed rice products having various functions such as maintenance of health and prevention of diseases are provided. Since such a substance can be retained in rice grains under ordinary pressure and ordinary temperature, manufacturing with a high productivity is possible.

1. A substance-retaining cereal produced by impregnating a cereal grain with a substance to be retained by utilizing a difference in osmotic pressure between the inside and the outside of the cereal grain under non-pressurized conditions, and then retaining the substance in the cereal grain, wherein
the cereal is double mutant rice (wx/ae rice) having deficiencies in both amylopectin branching enzyme (BEIIb) and amylose synthetase I (GBSSI), and the substance to be retained is at least any one of water-soluble substances and hydrophobic substances.

2. The substance-retaining cereal according to claim 1, wherein the substance to be retained is a water-soluble substance having a molecular weight of 300 or more.

3. The substance-retaining cereal according to claim 1, wherein the water-soluble substance is any one of digestion resistant dextrin, arabinogalactan, polyphenol, and pullulan.

4. The substance-retaining cereal according to claim 1, wherein the substance to be retained is a hydrophobic substance that is dispersible in water.

5. The substance-retaining cereal according to claim 1, wherein the substance is retained in the cereal grain in an amount of 1% by weight or more based on the amount of the cereal grain before the retaining.

6. A method of producing the substance-retaining cereal according to claim 1, comprising the steps of:
immersing a cereal grain in an aqueous solution or dispersion of a substance to be retained under ordinary pressure; and
drying the immersed cereal grain.

7. The method according to claim 6, wherein the immersing is performed using an aqueous solution or dispersion of the substance to be retained at ordinary temperature.

8. The method according to claim 6, wherein the immersed cereal grain is dried at 60° C. or less.

9. A processed cereal food produced from the substance-retaining cereal according to claim 1.

10. A processed cereal food produced by heat treatment of a cereal grain immersed in an aqueous solution or dispersion of a substance to be retained under non-pressurized conditions, wherein
the cereal is double mutant rice (wx/ae rice) having deficiencies in amylopectin branching enzyme (BEIIb) and amylose synthetase I (GBSSI), and the substance to be retained is at least any one of water-soluble substances and hydrophobic substances.

11. The processed cereal food according to claim 10, wherein the substance to be retained is any one of digestion resistant dextrin, arabinogalactan, polyphenol, and pullulan.
